(19) United States
(12) Patent Application Publication
(10) Pub. No.: US 2010/0300950 A1
(43) Pub. Date: Dec. 2, 2010

(54) Acoustically Optimised Fluid Line

(75) Inventors: Matthias Kadler, Frankfurt (DE); Karl Eck, Lahnstein (DE); Dieter Hagist, Gross-Gerau (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automative GmbH, Hannover (DE)

(21) Appl. No.: 12/680,389

(22) PCT Filed: Sep. 24, 2008
(86) PCT No.: PCT/EP2008/062717

§ 371 Date: Mar. 26, 2010

(30) Foreign Application Priority Data
Sep. 26, 2007 (DE) 10 2007 046 256.7

(51) Int. Cl. B01D 35/02; F04B 39/00

(52) U.S. Cl. 210/232; 210/416.1; 210/416.4; 417/572

(57) ABSTRACT

A fluid line for transporting fuel from a pump pre-filter to a fuel pump, which damps the noises of the fuel pump and a fuel delivery unit that is equipped with said fluid line Damping is achieved by at least one damping region, which is situated opposite the intake opening and which damps vibrations originating from the fuel pump.

### PRIORITY CLAIM

This is a U.S. national stage of application No. PCT/EP2008/062717, filed on 24 Sep. 2008, which claims priority to the German Application No.: 10 2007 046 256.7, filed: 26 Sep. 2007; the content of both incorporated herein by reference.

### BACKGROUND OF THE INVENTION

1. Field of the Invention

The invention relates to an acoustically optimized fluid line for transporting fluid between a pump and a pump pre-filter. The invention also relates to a fuel filter unit and to a fuel pump unit having the acoustically optimized fluid line.

2. Prior Art

Fuel delivery units for delivering fuel from the tank to the engine are conventionally accommodated in the tank of a motor vehicle. Components of a fuel delivery unit include a fuel pump, a pump pre-filter, and a swirl pot in which the fuel pump is arranged, such that the pump does not run dry even when driving around a curve or when the vehicle is in an inclined position.

The pre-filter is connected upstream of the fuel pump. Said pre-filter filters the fuel before it is pumped to the engine by the pump. Such a pump pre-filter may be arranged in the base of the swirl pot, such that the pump pumps the fuel through the pre-filter in the base of the swirl pot. A problem of such an arrangement, however, is that only the base surface of the swirl pot is available as a filter surface. This concept is therefore only suitable for relatively small engines.

Alternatively, both the pump and also the pump pre-filter may be arranged in the interior of the swirl pot. In this case, the pump, which usually has an elongate shape, is normally positioned in the swirl pot perpendicularly with respect to the base of the swirl pot. In this arrangement, the intake opening of the pump is normally arranged in the lower region of the swirl pot, in the vicinity of the base. The pre-filter and the inlet of the pump are connected to one another by a fluid line. The fuel flows out of the pump pre-filter, is then conducted by the fluid line in a duct in order to then be conducted under the pump and substantially vertically upward into the pump. The pump pre-filter may be matched in terms of its shape to the spatial conditions in the swirl pot.

### SUMMARY OF THE INVENTION

The present invention can be used in an arrangement in which the pre-filter is not arranged in the base of the swirl pot.

Fuel pumps can operate in different ways. Gasoline pumps can be the source of audible and disturbing noises in the motor vehicle. As a result of the pumping process, the fuel pump emits pressure waves out of its intake opening, which pressure waves can incite other parts of the fuel delivery device to resonate. This leads to a disturbing noise in the motor vehicle.

In fuel delivery units in which the fuel pump, as described above, is arranged substantially perpendicular to the base of the swirl pot and the pump pre-filter is not arranged in the base of the swirl pot, such noises can inter alia be generated or intensified in the fluid line which connects the pump pre-filter to the pump. Said fluid lines are specifically designed such that the pump is arranged at a pump connection which is normally of cylindrical design. In fluid lines according to the prior art, an impact plate is situated at that end of the cylinder which is situated opposite the pump. Since the impact plate is arranged opposite the intake opening of the pump, pressure waves or pressure surges, which are discharged out of the intake opening, impinge directly on the impact plate. The latter is thereby incited to resonate and generates an audible noise.

It is therefore an object of the present invention to specify a fluid line for connecting a pre-filter to a fuel pump, in which the size of the fuel filter is not limited by the base surface of the swirl pot, but which operates quietly, without noise emission or with reduced noise emission in relation to the prior art.

The invention relates to a fluid line for transporting fluid between a pump pre-filter and a pump. The pump may be connected with its intake or discharge opening to a pump connection of the fluid line. Said pump connection is connected to a duct through which fluid can pass, to the other side of which a pump pre-filter can be connected. For this purpose, the duct may open out into a filter connection. The filter connection may be designed as a simple opening or have further parts for attaching a filter. The fluid line may also be designed as a constituent part of a pre-filter, integrally connected to the latter.

The pump connection for connecting a pump has, at one side, a pump connection opening through which fuel flows from or to the pump. The pump connection also has a base which is situated opposite the pump connection opening. The pump connection opening preferably lies in a plane and can be of circular design for the connection of a circular intake or discharge opening. For the sake of simple producibility, it is preferable if the base also has a circular edge. The base may, but need not, be planar and may lie parallel to the pump connection opening. The diameter of the base is preferably substantially equal to the diameter of the pump connection opening. In this case, the pump connection preferably has a cylindrical wall between the pump connection opening and base, which has an opening for the duct.

The reduction in noise emitted by the pump is achieved according to one embodiment of the invention in that the base of the pump connection has at least one damping region that dampens fluid-borne vibrations directed toward said region, which vibrations thus impinge on said region. Vibrations of a pump which are emitted substantially in the direction of the base and impinge on the latter are thus dampened by said region.

For the design of the base of the pump connection and of the damping region, there are various options that achieve the desired noise damping. Arrangements in which the damping region is formed entirely or in regions as a filter, sieve, or as a perforated surface are particularly effective. To ensure that no bypass is generated passed the pump pre-filter, it is advantageous for the filter, the sieve and the perforated surface to have a pore size, a mesh size or a hole size that is smaller than or equal to the pore size or mesh size of the pump pre-filter, or to have at least the same filtration efficiency as or a higher filtration efficiency than the pre-filter connected to the fluid line.

For simple and cost-effective production, it is preferable for the damping region to be formed as an opening in the base, which opening extends through said base and in, in front of or over which opening the filter, the sieve or the perforated surface is arranged so as to completely cover or fill out said opening. The filter, the sieve or the perforated surface are arranged such that the fluid flowing through the opening also flows through the filter, the sieve or the perforated surface.

To enable particularly cost-effective production of the fluid line according to one embodiment of the invention, the filter, the sieve and/or the perforated surface may be pressed, welded or adhesively bonded onto the lower side or upper side of the base. A filter that can be plugged into and latches in the opening is particularly easy to produce, and therefore preferable. For this purpose, a groove may run around along the edge of the opening, with the edge of the filter, of the sieve or of the perforated surface snapping into said groove. Any possible force-fitting connection is conceivable for the fastening.

In addition to or instead of a filter, sieve or perforated surface, the damping region may also be designed in some other way so as to dampen vibrations which are directed towards it. preferably the damping region has a hydraulic resistance that serves to dampen the vibration energy.

Said duct, through which fluid can pass, branches off from the pump connection. Said duct may branch off between the pump connection opening and the base or may branch off from the base. A pump pre-filter can be connected to the other side of said duct. The duct may however also lead directly into the pre-filter, which is also to be understood to mean a connection of the filter.

To enable as space-saving an arrangement of the fuel pump and pump pre-filter in the swirl pot as possible, the fluid line may be designed such that the duct ends in a filter connection opening situated in a plane parallel to the plane in which the pump connection opening is situated. The position of the filter connection opening is however dependent on the shape of the filter. The duct of the fluid line may also open out directly into the filter.

The filter may be cylindrical and positioned with its cylinder axis parallel to the pump. The filter may however also be designed as a flat cuboid. This may be arranged with its surface parallel to the pump. It may however also be bent in its surface through 90° such that one part of lies parallel to the base of the swirl pot and another part lies parallel to the longitudinal direction of the pump or parallel to the wall of the swirl pot. In said case, a filter connection opening may be positioned with its area perpendicular to the base of the swirl pot or to the base of the pump connection. The fluid flows through the surface of said cuboid and is conducted through the duct, which opens out into the interior of the cuboid, to the pump. A flat or bent cuboidal pre-filter may be produced particularly easily if a filter fabric or filter material is tensioned over a filter support structure. For a cuboidal shape of the filter, the filter support structure may be of areal design, with spacers of substantially constant height projecting out of the surface, which spacers push the filter fabric outward and thereby tension said filter fabric in a cuboidal shape.

For the possibility of a space-saving arrangement of a fuel pump and pump pre-filter, it is also advantageous if the duct that connects the pump connection to a pre-filter runs with its throughflow direction in a plane which lies parallel to the plane of the pump connection opening or to the base of the pump connection. The duct may have different cross-sectional shapes, and may for example be rectangular or circular or elliptical in cross section.

The fluid line and the fuel filter unit according to one embodiment of the invention is equipped with said line permit a space-saving arrangement even of large pump filters in a swirl pot together with the fuel pump. Here, the problems arising in the prior art with regard to the emission of noise are simultaneously eliminated. The filtering of the fuel is nevertheless not impaired.

### BRIEF DESCRIPTION OF DRAWINGS

The invention will be explained below on the basis of some examples. The examples are in no way to be considered restrictive, and the features presented therein may also be used in other combinations in the fluid line according to the invention and in the fuel filter and pump units. Corresponding features are denoted by the same reference numerals.

In the figures:

FIG. 1 is a perspective view of a fuel filter unit with a fluid line according to one embodiment of the invention;

FIG. 2 is a perspective view of a fuel filter unit with a fluid line according to the invention, with the filter being bent by 90°;

FIG. 3 is a perspective view of a fuel filter unit with a fluid line according to the invention;

FIG. 4 is a side view of the fuel filter unit of FIG. 3; and

FIG. 5 is a top view of a fuel pump unit.

### DETAILED DESCRIPTION OF THE DRAWINGS

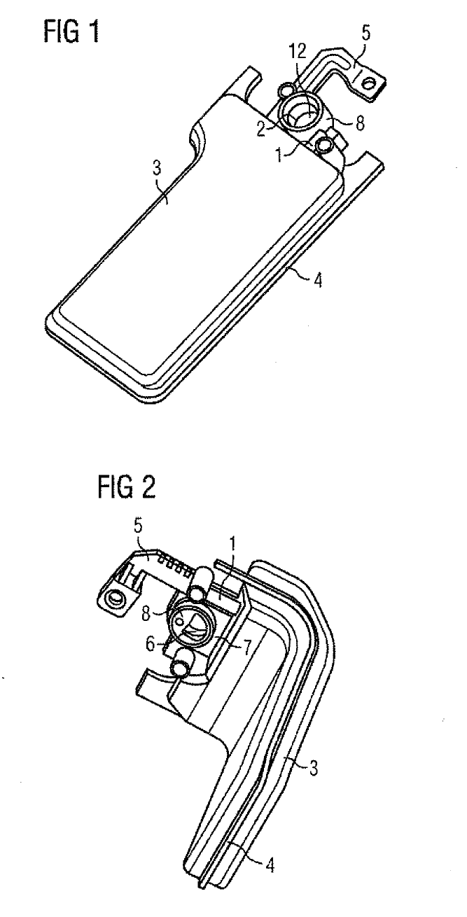

FIG. 1 shows a fuel filter unit according to one embodiment of the invention with a fluid line 1 and pump connection 8 which is visible. FIG. 1 shows that side of the fuel filter unit which, when installed in a swirl pot, faces toward a base of the swirl pot. Of the substantially cylindrical pump connection 8, therefore, it is possible to see the circular base 12 of the pump connection 8 with the damping region 2. Connected to the fluid line 1 is a pump pre-filter 3 which is designed substantially as an areal cuboid. An areal cuboid is to be understood to be a cuboid in which two surfaces which are parallel to one another have a considerably greater area than the other side surfaces of the cuboid. In the example shown, the pre-filter 3 is tensioned on a filter support structure 4. The fuel filter unit shown also has a retaining element 5 by which it can be attached in a swirl pot.

FIG. 2 is a fuel filter unit according to the invention corresponding to FIG. 1. Shown here, however, is that side of the fuel filter unit which is not visible in FIG. 1. It is therefore possible to see the pump connection opening 6 of the pump connection 8. Here, the pump connection 8 has a cylindrical shape, such that the pump connection opening 6 is circular. A duct 7 through which fluid can pass extends from the cylinder wall of the pump connection opening 6. Duct 7 connects the pump connection 8 to the pre-filter 3. The pre-filter 3 in FIG. 2 is, in comparison with the pump pre-filter shown in FIG. 1, bent by an angle of about 90° about an axis that lies perpendicular to the cylinder axis of the cylindrical pump connection 8 and perpendicular to the passage opening of the duct 7. With a bent pre-filter 3 of said type, it is also possible for the fuel filter unit to be arranged in relatively small swirl pots. A fuel pump would, in FIG. 2, be connected to the pump connection opening 6 and would then be positioned substantially parallel to the bent part of the pre-filter 3.

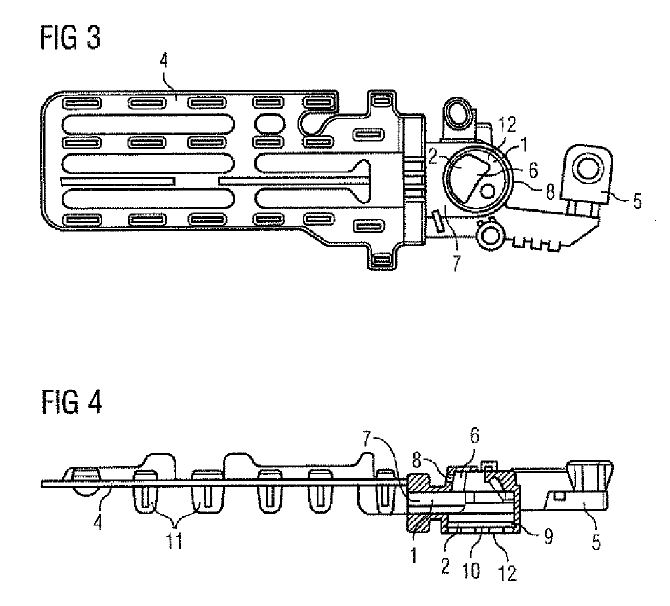

FIG. 3 depicts a fuel filter unit according to the invention with a fluid line 1. In contrast to FIG. 1 and FIG. 2, the filter material of the pre-filter 3 has been removed in FIG. 3, such that only the filter support structure 4 is shown. FIG. 3 shows the fuel filter unit in a plan view, such that if a fuel pump were connected to the pump connection opening 6, the fuel pump would project perpendicularly upward out of the plane of the drawing. It is possible to see the pump connecting piece 8 with the pump connection opening 6 facing toward the viewer. Looking through the pump connection opening 6, it is possible to see, on the rear side of the pump connection 8, the base 12 of the pump connection 8 with the damping region 2, in which is arranged a filter, a sieve or a perforated surface. Parallel to the plane of the base 12, the duct 7 extends laterally through the cylindrical wall of the pump connection 8. Attached to the other end of said duct 7 is the filter support structure 4 over which the filter material is tensioned. Here, the filter support structure 4 defines the rectangular cross section of the pre-filter 3 and extends substantially parallel to the main surfaces of the areal pump pre-filter 3.

FIG. 4 shows the fuel filter unit according to the invention from FIG. 3 in a side view. It can be seen that the pump connection 8 opens to the top of the pump connection opening 6. Arranged opposite said pump connection opening is the damping region 2, which is designed here as a filter inserted into an opening. Here, the filter 10 snaps with its edge into a groove 9 which is arranged in the wall of the pump connection 8 so as to run around the opening into which the filter 10 is inserted. It can be seen that the fluid line 1 according to the invention has, in addition to the pump connection 8, a duct 7 the extends laterally out of the cylindrical wall of the pump connection 8 with a throughflow direction parallel to the base 12. The duct 7 connects the pump connection 8 to the interior of the pre-filter 3 which is tensioned by the filter holding structure 4. The latter has, for this purpose, projections 11 that project out of its surface and which push the pre-filter 3 outward in the tensioned state. The other elements shown correspond to the elements shown in the other figures.

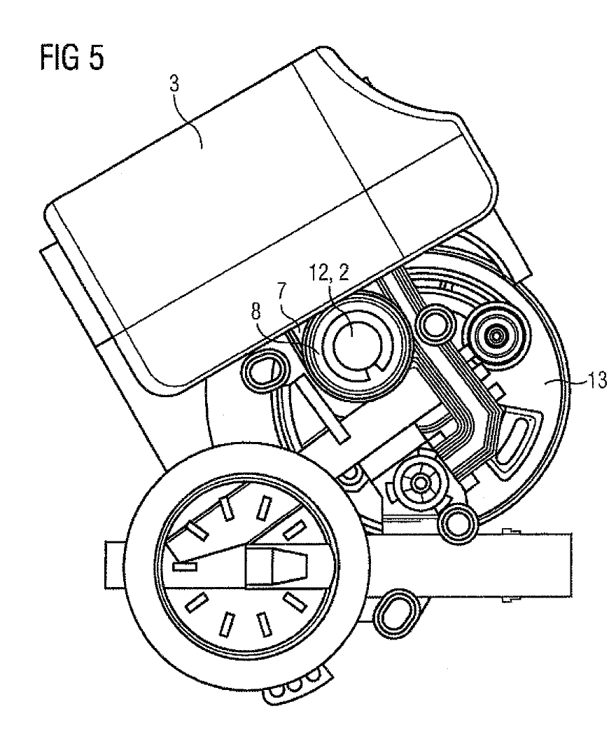

FIG. 5 shows a fuel pump unit according to the invention with fluid line 1 according to the invention in a view from below, that is to say from the direction of that side which faces toward the base of the swirl pot in the installed state.

The fuel pump 13 is connected by the pump connection 8 to the fluid line 1 according to the invention. Said fluid line 1 is in turn connected to the pump pre-filter 3. Here, fuel is conducted from the pump pre-filter 3 through the duct 7 of the fluid line 1 into the pump 13. Here, as shown in FIG. 2, the pump pre-filter 3 is bent.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A fluid line configured to transport fluid between a pre-filter and a pump, the fluid line comprising:
a pump connection with a pump connection opening configured to connect to one of an intake opening and a discharge opening of the pump;
a base of the pump connection arranged opposite the pump connection opening having an upper side, which faces toward the pump connection opening, and a lower side which faces away from the pump connection opening;
a duct, through which fluid can pass, configured to connect the pump connection to the pre-filter, the duct having a first end opening into the pump connection and a second end opposite the first end configured to connect to the pre-filter; and
a damping region arranged in the base of the pump connection configured to damp vibrations radiated in a direction of the base in the fluid.

17. The fluid line as claimed in claim 16, wherein the damping region is formed as at least a part of one of a filter, a sieve, and a perforated surface.

18. The fluid line as claimed in claim 16, wherein
the damping region is configured as an opening from the upper side to the lower side,
the opening is one of filled and covered by at least one of a filter, a sieve, and a perforated surface, and
upstream of the opening at least one of a further filter, a further sieve and a further perforated surface is arranged such that a flow of the fluid through the opening leads to the fluid flowing through the one of the filter, the sieve, and the perforated surface.

19. The fluid line as claimed in claim 17, wherein the at least one of the filter, the sieve, and the perforated surface is affixed onto one of the lower side or upper side of the base.

20. The fluid line as claimed in claim 17, wherein the at least one of the filter, the sieve, and the perforated surface has at least one of:
a mesh size that is smaller than or equal to a mesh size of the pre-filter, and
a filtration efficiency which is equal to or greater than a filtration efficiency of the pre-filter.

21. The fluid line as claimed in claim 16, wherein the first end of the duct is arranged one of between the pump connection opening and the base and through the base.

22. The fluid line as claimed in claim 16, further comprising a filter connection opening arranged in a plane parallel to a plane in which the pump connection opening is situated.

23. The fluid line as claimed in claim 16, further comprising a filter connection opening that is one of
arranged in a plane perpendicular to a plane in which the pump connection opening is situated, and
opens in a direction perpendicular to a direction in which the pump connection opening opens.

24. The fluid line as claimed in claim 23, wherein the duct is arranged parallel to a plane in which the pump connection opening extends.

25. The fluid line as claimed in claim 16, wherein at least a portion of the duct has a rectangular cross section.

26. The fluid line as claimed in claim 16, wherein a cross section of the pump connection opening is circular.

27. A fuel filter unit comprising:
a prefilter; and
a fluid line configured to transport fluid between the pre-filter and a pump, the fluid line comprising:
a pump connection with a pump connection opening configured to connect to one of an intake opening and a discharge opening of the pump;
a base of the pump connection arranged opposite the pump connection opening having an upper side, which faces toward the pump connection opening, and a lower side which faces away from the pump connection opening;
a duct, through which fluid can pass, configured to connect the pump connection to the pre-filter, the duct having a first end opening into the pump connection and a second end opposite the first end configured to connect to the pre-filter; and
a damping region arranged in the base of the pump connection configured to damp vibrations radiated in a direction of the base in the fluid.

28. A fuel pump comprising:
a fluid line configured to transport fluid between a pre-filter and a pump, the fluid line comprising:
a pump connection with a pump connection opening configured to connect to one of an intake opening and a discharge opening of the pump;
a base of the pump connection arranged opposite the pump connection opening having an upper side, which faces toward the pump connection opening, and a lower side which faces away from the pump connection opening;
a duct, through which fluid can pass, configured to connect the pump connection to the pre-filter, the duct having a first end opening into the pump connection and a second end opposite the first end configured to connect to the pre-filter; and
a damping region arranged in the base of the pump connection configured to damp vibrations radiated in a direction of the base in the fluid; and
a fuel pump connected to the pump connection of the fluid line.

29. A fuel delivery comprising:
a fuel pump;
a pre-filter; and
a fluid line configured to transport fluid between the pre-filter and the pump, the fluid line comprising:
a pump connection with a pump connection opening configured to connect to one of an intake opening and a discharge opening of the pump;
a base of the pump connection arranged opposite the pump connection opening having an upper side, which faces toward the pump connection opening, and a lower side which faces away from the pump connection opening;
a duct, through which fluid can pass, configured to connect the pump connection to the pre-filter, the duct having a first end opening into the pump connection and a second end opposite the first end configured to connect to the pre-filter; and
a damping region arranged in the base of the pump connection configured to damp vibrations radiated in a direction of the base in the fluid,
wherein the fuel pump is connected by one of the intake and the discharge opening to the pump connection opening of the fluid line and the pre-filter is connected the second end of the duct of the fluid line which is situated opposite the first end of the duct that opens out into the pump connection of the fluid line.

29. The fuel delivery unit as claimed in claim 28, wherein the fuel pump and the pre-filter each have an elongate shape in one direction at least in a respective region that are arranged substantially parallel to one another.

30. The fluid line as claimed in claim 19, wherein the at least one of the filter, the sieve, and the perforated surface is affixed by one of pressing, welding, and adhesive bonding.

31. The fluid line as claimed in claim 17, wherein the at least one of the filter, the sieve, and the perforated surface is inserted into and latched in the opening.

32. The fluid line as claimed in claim 13, further comprising a filter connection opening arranged to open in a same direction as the pump connection opening.
